(19) United States
(12) Patent Application Publication
(10) Pub. No.: US 2026/0244493 A1
(43) Pub. Date: Aug. 20, 2026

(54) TASK PERFORMANCE IN VISION-LLMS VIA TASK DECOMPOSITION AND PROGRAM OF THOUGHT VERIFICATION

(71) Applicant: SRI International, Menlo Park, CA (US)

(72) Inventors: Ajay DIVAKARAN, Monmouth Junction, NJ (US); Pritish SAHU, New Brunswick, NJ (US); Karan SIKKA, Robbinsville, NJ (US)

(21) Appl. No.: 19/544,206

(22) Filed: Feb. 19, 2026

Related U.S. Application Data
(60) Provisional application No. 63/760,959, filed on Feb. 20, 2025.

(51) Int. Cl. G06F 9/48; G06N 5/04

(52) U.S. Cl. CPC G06F 9/4881; G06N 5/04

(57) ABSTRACT

A method, apparatus, and system for task performance in a Vision Large Language model (Vision-LLM) include decomposing an original task request associated with an image and received at the Vision-LLM into sub-tasks to divide the received original task request into less complex sub-tasks, converting the sub-tasks into code to select at least one respective tool for a performance of each sub-task, performing each sub-task using the selected, respective tool, aggregating the results of the sub-task performances, and applying reasoning to the aggregated results to determine if the original task request was performed correctly.

### RELATED APPLICATION

This application claims benefit to U.S. Provisional Patent Application Ser. No. 63/760,959, filed Feb. 20, 2025 and entitled “Correcting Hallucination in Vision-LLMs via Claim Decomposition and Vision of Thought Verification ,” which is hereby incorporated herein in its entirety by reference.

### FIELD

Embodiments of the present principles generally relate to Vision Large Language Models (LLMs) such as Large Visual Language Models (LVLMs) and, more particularly, to methods, apparatuses and systems for task performance in Vision-LLMs via task decomposition and program of thought verification.

### BACKGROUND

Vision Large Language Models (Vision-LLMs) such as Large Visual Language Models (LVLMs), are types of artificial intelligence (AI) algorithms that use deep learning techniques and massively large data sets to understand, summarize, generate and predict new content. In particular, Large Visual Language Models (LVLM) typically integrate visual tokens into the embedding space of a Large Language Model (LLM), leveraging the linguistic capabilities of LLMs while incorporating visual information for multimodal understanding.

LLMs and LVLMs, however, often struggle with natural language processing despite their proficiency in generating it. The limitations stem from a lack of true comprehension, relying instead on pattern matching and probabilistic text prediction. This leads to issues with complex reasoning, logical consistency, and understanding context.

LVLMs, in particular, have problems performing tasks using natural language processing. For example, in some instances, LVLMs are affected by hallucinations (i.e., a determination of results that are incorrect, fabricated, or nonsensical) when implementing natural language processing. Hallucinations are a critical problem in the application of LVLMs in real-world applications. Most current approaches to addressing the problem of hallucinations in LVLMs are aimed at reducing hallucinations by improving the underlying model for example by increasing the amount of data used for training. Such approaches, however, have issues with quality of training data and limitations of end-to-end training. Such issues limit the trustworthiness of LVLMs.

Thus, there is a need for improved techniques for reducing processing problems associated with natural language processing of task requests in Vision-LLMs and, in particular, in Large Visual Language Models (LVLMs).

### SUMMARY

Embodiments of the present principles generally relate to methods, apparatuses and systems for performing tasks in Vision Large Language Models such as Large Visual Language Models (LVLMs) using task decomposition and program of thought (POT) verification as shown in and/or described in connection with at least one of the figures.

In some embodiments, a method for task performance in a Vision Large Language model (Vision-LLM) includes decomposing an original task request associated with an image and received at the Vision-LLM into sub-tasks to divide the received task request into less complex sub-tasks, converting the sub-tasks into code to select at least one respective tool for a performance of each sub-task, performing each sub-task using the selected, respective tool, aggregating the results of the sub-task performances, and applying reasoning to the aggregated results to determine if the original task request was performed correctly.

In some embodiments, an apparatus for task performance in a Vision Large Language model (Vision-LLM) includes at least one processor, and a memory accessible to the processor, the memory having stored therein at least one of programs or instructions. In some embodiments, when the programs or instructions are executed by the processor, the apparatus is configured to decompose an original task request associated with an image and received at the Vision-LLM into sub-tasks to divide the received task request into less complex sub-tasks, convert the sub-tasks into code to select at least one respective tool for a performance of each sub-task, perform each sub-task using the selected, respective tool, aggregate the results of the sub-task performances, and apply reasoning to the aggregated results to determine if the original task request was performed correctly.

In some embodiments, a system for task performance in a Vision Large Language model (Vision-LLM) includes a Vision-LLM, and an apparatus including at least one processor, and a memory accessible to the processor, the memory having stored therein at least one of programs or instructions. In some embodiments, when the programs or instructions are executed by the processor, the system is configured to decompose an original task request associated with an image and received at the Vision-LLM into sub-tasks to divide the received task request into less complex sub-tasks, convert the sub-tasks into code to select at least one respective tool for a performance of each sub-task, perform each sub-task using the selected, respective tool, aggregate the results of the sub-task performances, and apply reasoning to the aggregated results to determine if the original task request was performed correctly.

In some embodiments, a non-transitory computer readable medium having stored thereon instructions that, when executed by one or more processors, cause the one or more processors to perform operations for task performance in a Vision Large Language model (Vision-LLM), that include decomposing an original task request associated with an image and received at the Vision-LLM into sub-tasks to divide the received task request into less complex sub-tasks, converting the sub-tasks into code to select at least one respective tool for a performance of each sub-task, performing each sub-task using the selected, respective tool, aggregating the results of the sub-task performances, and applying reasoning to the aggregated results to determine if the original task request was performed correctly.

These and other features and advantages of the present principles may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles of the invention may admit to other equally effective embodiments.

FIG. 1 depicts a high-level block diagram of a Vision-LLM task performance system in accordance with at least one embodiment of the present principles.

FIG. 2 depicts an example of a visual table in accordance with at least one embodiment of the present principles.

FIG. 3 depicts a graphical representation of a computational graph of generated sub-claims of the present principles including predicates as the node and edges defined by their dependencies in accordance with at least one embodiment of the present principles.

FIG. 4 depicts a Table including examples of predicates determined by, for example, the claim decomposition module, respective tools selected to execute the action of the predicate, and the reasoning of the implementation of the tool in accordance with at least one embodiment of the present principles.

FIG. 5 graphically depicts a functional diagram of the operation of a Vision-LLM task performance system in accordance with at least one embodiment of the present principles.

FIG. 6A depicts a flow diagram of a method for performing task requests in vison large language models in accordance with at least one embodiment of the present principles.

FIG. 6B depicts a flow diagram of a method for performing the task of verifying claims in vison large language models in accordance with at least one alternate embodiment of the present principles.

FIG. 7 depicts a high-level block diagram of a computing device suitable for use with embodiments of a Vision-LLM task performance system in accordance with at least one embodiment of the present principles.

FIG. 8 depicts a high-level block diagram of a network in which embodiments of a Vision-LLM task performance system in accordance with the present principles can be implemented.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for performing tasks in Vision Large Language Models, such as Large Visual Language Models (LVLMs), using task decomposition and program of thought verification. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described herein primarily with respect to Large Language Models (LLMs) including visual components (Visual-LLMs), such teachings should not be considered limiting. For example, embodiments of the present principles for performing tasks can be applied to text based LLMs as described herein for Visual-LLMs. The features implemented in one embodiment may be implemented in another embodiment where logically possible. The specific details can be varied from and still be contemplated to be within the spirit and scope of what is being disclosed.

In the disclosure herein, the terms “Vision Large Language Model” and “Vision-LLM” are intended to describe and define any Large Language Model (LLM) that incorporates visual information for multimodal understanding. That is, a Vision-LLM of the present principles describes an artificial intelligence (AI) algorithm that uses deep learning techniques and massively large data sets including visual information to perform tasks which can include to understand, summarize, generate and predict new content.

In the disclosure herein, the terms “Large Visual Language Model” and “LVLM” are intended to define and describe a specific type of Vision-LLM and specifically a type of AI that combines a computer vision encoder with a Large Language Model (LLM) to process, understand, and reason across both images/video and text.

In the disclosure herein, the phrases “less complex task request”, “less complex sub-task”, “less complex sub-question”, “less complex claim” and the like are intended to define and describe a task request, sub-task, sub-question and/or a claim that requires less reasoning, less complicated tools, less computational resources, and the like to resolve.

Embodiments of the present principles provide methods, apparatuses and systems for task performance in Vision-LLMs, such as LVLMs, by using task decomposition and program of thought (POT) verification. In some embodiments, a visual task request input to a LVLM can be decomposed into a chain of sub-tasks to divide the received task request into less complex sub-tasks. In some embodiments, the task request can be divided into sub-tasks, for example, based on objects in an image that are subject of the task request. Subsequently, in some embodiments of the present principles, a system of the present principles is configured to generate intermediate, executable code to resolve the sub-tasks, rather than using natural language. For example, in some embodiments, Program-of-Thought (POT) prompting is used to generate Python code for performing tasks/sub-tasks through flexible generation/calling of tools (e.g., external tools). That is, in embodiments of the present principles, the executable code is used to generate/select a respective tool for performing each of the sub-tasks.

In embodiments of the present principles, the results of the sub-tasks are aggregated, and reasoning is applied to the aggregated results to determine if the original task was performed correctly. For example, in some embodiments, the reasoning of an associated Vision-LLM/LVLM can be applied to the aggregated sub-task results for determining if the original task was performed correctly.

In some embodiments, a system for performing tasks of the present principles can propose a refinement to the task performance based on the results of the reasoning. For example, if from the reasoning, it is determine that the original task was not performed correctly, a system of the present principles can suggest a further task or a refinement/modification of the original task based on the reasoning, to attempt to accomplish the correct performance of the original task.

In some embodiments, the performance of task requests in LVLMs of the present principles optionally includes the implementation of intermediate variables for the precise grounding of object instances. That is, the intermediate variable helps embodiments of the present principles to reference specific object instances (e.g. object on the right). Such a process of the present principles improves the performance of tasks/sub-tasks requiring contextual reasoning around multiple objects.

In some embodiments, a system for performing tasks in accordance with the present principles can optionally further include using shared computations for performing the generated sub-tasks to enable adaptive corrections and inconsistency identification. That is, the system of the present principles can provide the answers derived in the performance of a previous sub-task as context when answering a next sub-task in a chain of sub-tasks. This process can reduce duplicate computations, adaptively correct follow-up questions and can also catch inconsistencies in the reasoning process resulting from errors in visual tools being applied.

As such, various embodiments of the present principles provide task performance in a Vision-LLM by (1) generating sub-tasks from an original task, (2) converting the sub-tasks to code, (3) selecting a respective tool for performing each of the sub-tasks (4) using reasoning abilities to verify a correctness of a performance of the original task. In some embodiments, the task performance of the present principles can optionally further include (5) implementing intermediate variables for precise grounding of object instances, and (6) using shared computation for performing the generated sub-tasks to enable adaptive corrections and inconsistency identification.

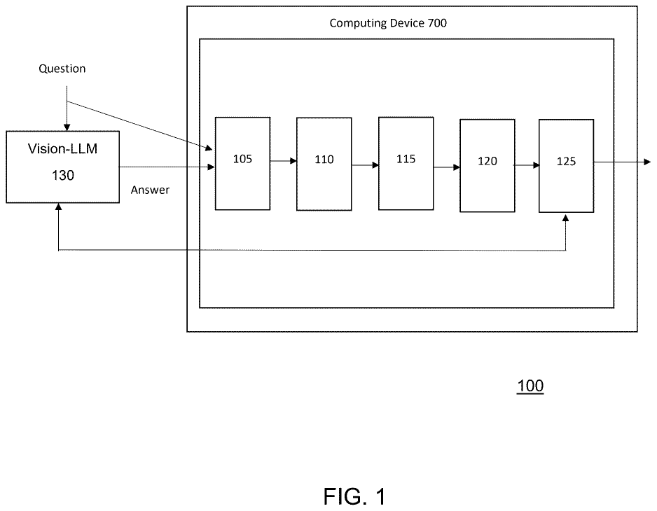

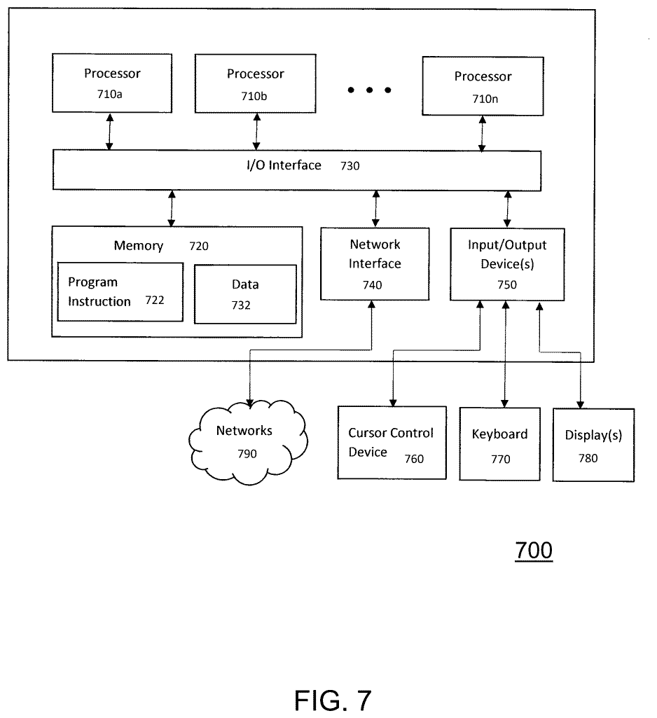

FIG. 1 depicts a high-level block diagram of a Vision-LLM task performance system 100 in accordance with at least one embodiment of the present principles. The Vision-LLM task performance system 100 of FIG. 1 illustratively comprises an optional task creation module 105, an optional grounding module 110, a task decomposition module 115 illustratively including an optional machine learning (ML) model/algorithm 117, a coding module 120, and a reasoning module 125. FIG. 1 further includes a LVLM 130. As depicted in FIG. 1, embodiments of a Vision-LLM task performance system of the present principles, such as the Vision-LLM task performance system 100 of FIG. 1, can be implemented via a computing device 700 in accordance with at least one embodiment the present principles (described in greater detail below with respect to FIG. 7). Although in the embodiment of FIG. 1, the Vision-LLM task performance system of the present principles is depicted as a separate component from the LVLM 130, in alternate embodiments of the present principles, a Vision-LLM task performance system of the present principles can be integrated into the LVLM 130 as a combined unit.

In the embodiment of FIG. 1, the optional task creation module 105 of the Vision-LLM task performance system 100 can receive a task that was input to the LVLM 130 and puts it in a form understandable to the task decomposition module 115 for creating sub-tasks. For example, in embodiments in which a Vision-LLM task performance system of the present principles, such as the Vision-LLM task performance system 100 of FIG. 1, is being implemented to perform the task of verifying a correctness of an answer, â, to a question, \hat{q}, generated by the LVLM 130 and as depicted in FIG. 1, the question-answer pair, (\hat{q}, â), are combined into an original task for the image by the optional task creation module 105.

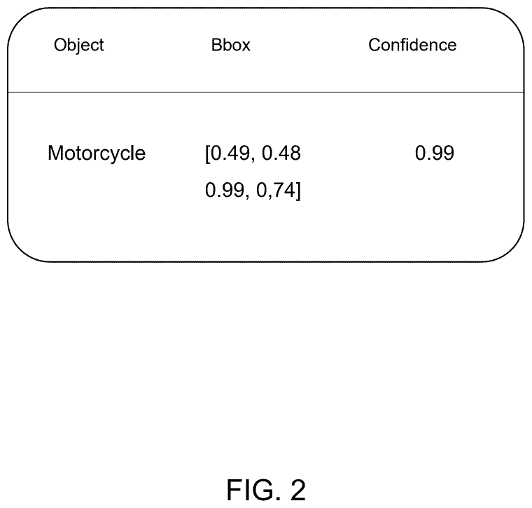

In some embodiments, the original task created by the optional task creation module 105 can be communicated to the optional grounding module 110 of the Vision-LLM task performance system 100 of FIG. 1. The optional grounding module 110 can implement object detectors to ground visual entities in the given image relevant to the claim. In some embodiments, the grounding module 110 implements a pipeline that can utilize YOLO and Grounding-DINO to determine the presence and location of objects in a given image. Given the image and the task, the grounding module 110 can produce a visual table representation by first parsing the task using, for example the LVLM 130, with in-context examples to identify key entities that are tangible and that can be visually grounded. This is done to reduce the likelihood of false positives. For example, for the task “Change the color of the motorcycle in the image” can be parsed into {motorcycle and color}. The entity is then identified to the object detectors to create a visual table of the present principles. For example, FIG. 2 depicts an example of a visual table in accordance with at least one embodiment of the present principles. The visual table of FIG. 2 illustratively comprises a column identifying the object (a motorcycle), a column identifying the bounding box of the object, and a column identifying a confidence score for the object (0.99).

Referring back to the Vision-LLM task performance system 100 of FIG. 1, the original task can be communicated to the task decomposition module 115. The task decomposition module decomposes/divides the original task into less complex sub-tasks. For example, in some embodiments, to decompose/divide the original task into sub-tasks, an LLM/LVLM can be used to determine the sub-tasks. That is, a LLM/LVLM can be implemented (i.e., by asking the LLM/LVLM) to determine what sub-tasks would need to be performed to perform the original task.

Alternatively or in addition, in some embodiments a machine learning model can be implemented to decompose/divide sub-tasks for an original task. For example, in some embodiments, the task decomposition module 115 of the present principles can include a trained ML model/algorithm 117 implementing a NN for decomposing/dividing the original task into sub-tasks. For example, in some embodiments of the present principles, the task decomposition module 115 of a Vision-LLM task performance system of the present principles, such as the Vision-LLM task performance system 100 of FIG. 1, can include a ML model/algorithm 117 to decompose/divide an original task into sub-tasks in accordance with the present principles. In some embodiments, the ML model/algorithm 117 can include a multi-layer neural network comprising nodes that are trained to have specific weights and biases. In some embodiments, the ML model/algorithm 117 of the task decomposition module 115, employs artificial intelligence techniques or machine learning techniques to decompose/divide tasks input to a Vision-LLM to determine sub-tasks. That is, in some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML model/algorithm 117 of the present principles can be trained using hundreds, to thousands, to millions of instances of original task requests and corresponding decomposed/divided sub-tasks to be used to generate models that can be compiled as an ensemble of models in accordance with the present principles. Over time, the model/algorithm learns to look for specific attributes in the original task requests and the decomposed/divided sub-tasks to determine at least one model that can be used to decompose/divide an original task request into sub-tasks in accordance with the present principles.

Referring back to FIG. 1, in some embodiments of the present principles the generated sub-tasks can be communicated to the coding module 120 of the Vision-LLM task performance system 100. To perform each sub-task generated by the claim decomposition module 115, the coding module 120 of the Vision-LLM task performance system 100 of FIG. 1 generates a visually grounded response to each sub-task by implementing executable code to solve complex problems, rather than using natural language. For example, in some embodiments, the coding module 120 implements a PoT-based strategy to synthesize programmatic instructions that composes different visual tools to perform the sub-tasks. For example, a sub-task involving the color of an object might be translated into a code snippet that first uses a detector to crop the object and then applies a VQA tool to determine the object's color in the image. A key advantage of using code to perform a sub-task, in accordance with the present principles, is the ability to combine different visual tools flexibly with Python operators. To perform robust task performance when performing each sub-task, in some embodiments the coding module 120 can share computations between sub-tasks. That is, the coding module information regarding tasks performed in previous sub-task as context when performing a next sub-task in a chain of sub-tasks. This process can reduce duplicate computations, adaptively correct follow-up questions and can also catch inconsistencies in the reasoning process resulting from errors in visual tools being applied. For example, a follow up sub-tasks involving a color of a car might not realize that multiple cars are present in the image and may thus end up generating code without loops over the object.

In the embodiment of FIG. 1, the results of the sub-tasks performed by the coding module 120 using the PoT-based processing are aggregated by the reasoning module 125 of the Vision-LLM task performance system 100 of FIG. 1 to perform a comprehensive reasoning assessment and determine if the original task(s) was performed correctly. The reasoning of the present principles can be crucial in some circumstances to verify a performance of the original task request and for drawing accurate and reliable conclusions. That is in some embodiments, the reasoning module 125 aggregates the performance of each sub-task to make an informed decision about the overall performance of the original task request. In some embodiments, to verify the validity of a performance of the original task and/or sub-tasks, the reasoning module 125 can implement an LLM (e.g. LVLM 130) by using a detailed instruction and a few in-context examples that encourages the LLM to verify the performance of a task and/or sub-task by considering the evidence along with the consistency and coherence of the generated results of a task using, in some embodiments, Chain-of-Thought (CoT)-style reasoning. In such embodiments, discrepancies or inconsistencies in the performance of a task(s) or sub-task(s) can be flagged, prompting a closer inspection of the questionable elements. This cross-examination of the present principles helps in identifying errors that may have arisen due to incorrect or ambiguous interpretations of the visual data and/or incorrect performance of a task(s) and/or sub-task(s).

To mitigate an identified incorrect performance of an original task request based on the aggregated results of the performance of the sub-tasks in accordance with the present principles, the reasoning module 125 can use the reasoning abilities of the same LLM (e.g., LVLM 130) to determine a task request to be communicated to the LVLM 130 and as such, to a Vision-LLM task performance system of the present principles, such as the Vision-LLM task performance system 100 of FIG. 1, to accomplish the tasks of the original task request. For example, if an original task request included the task of changing the color of a motorcycle in an image from blue to red, and the reasoning module 125 determined, using, for example, the reasoning abilities of an associated LLM (such as the LVLM 130) that only a portion of the motorcycle in the image was changed to red, the reasoning module 125 of the present principles can generate a task request to be communicated to the LVLM 130 and as such, to a Vision-LLM task performance system of the present principles, such as the Vision-LLM task performance system 100 of FIG. 1, to change the color of the remaining parts of the motorcycle in the image to red, thus providing a refinement to the original task request.

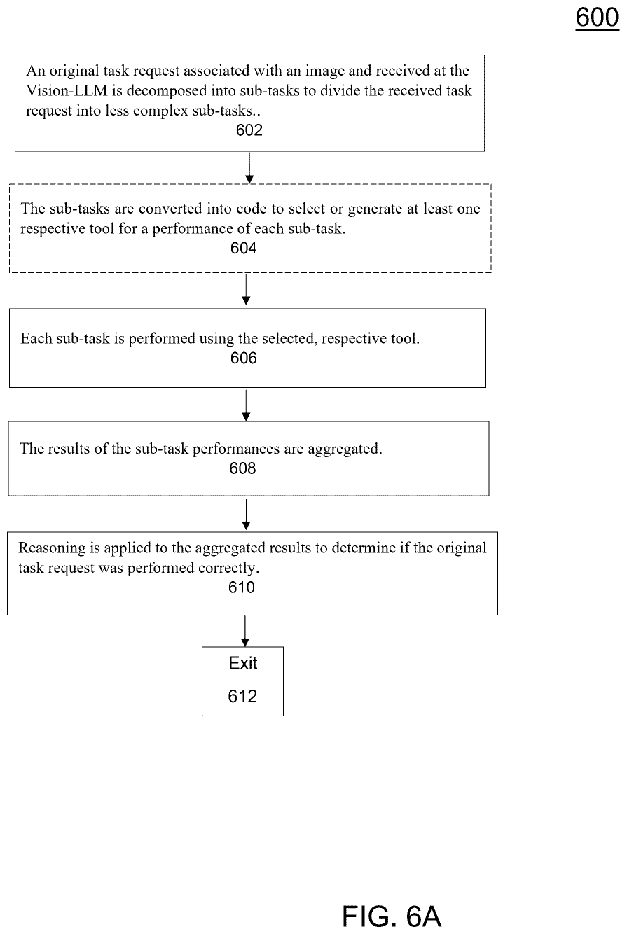

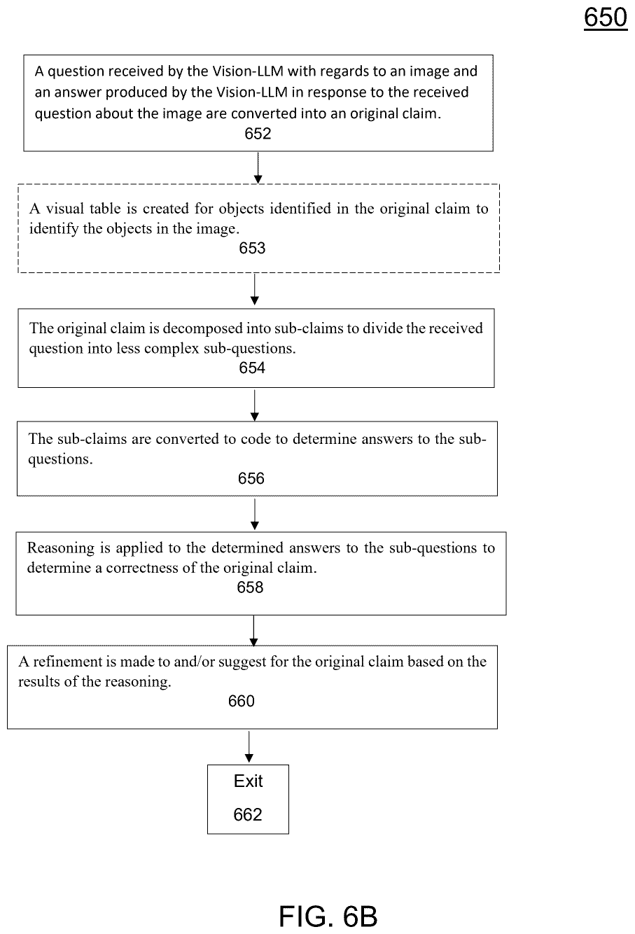

FIG. 6A depicts a flow diagram of a method 600 for performing task requests in vison large language models in accordance with at least one embodiment of the present principles. The method 600 can begin at 602 during which an original task request associated with an image and received at the Vision-LLM is decomposed into sub-tasks to divide the received task request into less complex sub-tasks. For example, in some embodiments and as described above, the original task request can be decomposed into sub-requests using a machine learning model. The method 600 can proceed to 604.

At 604, the sub-tasks are converted into code to select or generate at least one respective tool for a performance of each sub-task. For example and as described above, in some embodiments Program-of-Thought (POT) prompting is used to generate Python code for performing tasks/sub-tasks using selected tools. The method 600 can proceed to 606.

At 606, each sub-task is performed using the selected, respective tool. The method 600 can proceed to 608.

At 608, the results of the sub-task performances are aggregated. The method 600 can proceed to 610.

At 610, reasoning is applied to the aggregated results to determine if the original task request was performed correctly. For example and as described above, in some embodiments, the reasoning capabilities of an associated LLM, such as the Vision-LLM is implemented to determine if the original task request was performed correctly. The method 600 can exit at 612.

In some embodiments, a method of the present principles can further include determining a refinement to the aggregated results if needed, based on the determination if the original task request was performed correctly.

In some embodiments of the present principles, the code comprises Python code using the Program of Thought (POT) approach.

In some embodiments, a method of the present principles can further include generating an intermediate variable of the sub-tasks to ground at least one object in the image.

In some embodiments, a method of the present principles can further include creating a visual table from the original task request for objects identified in the original task request to identify at least one object in the image.

In some embodiments of the present principles, identifying at least one object in the image includes determining a bounding box for the at least one identified object and determining a confidence score for the at least one identified object.

In some embodiments, an apparatus for task performance in a Vision Large Language model (Vision-LLM) includes at least one processor and a memory accessible to the processor, the memory having stored therein at least one of programs or instructions. In some embodiments, when at least one of the programs or the instructions are executed by the processor, the apparatus is configured to decompose an original task request associated with an image and received at the Vision-LLM into sub-tasks to divide the received task request into less complex sub-tasks, convert the sub-tasks into code to select at least one respective tool for a performance of each sub-task, perform each sub-task using the selected, respective tool, aggregate the results of the sub-task performance, and apply reasoning to the aggregated results to determine if the original task request was performed correctly.

In some embodiments, the apparatus is further configured to determine a refinement to the aggregated results if needed, based on the determination if the original task request was performed correctly.

In some embodiments, the apparatus is further configured to generate an intermediate variable of the sub-tasks to ground at least one object in the image.

In some embodiments, the apparatus is further configured to generate a visual table from the original task request for objects identified in the original task request to identify at least one object in the image.

In some embodiments, a system for task performance in a Vision Large Language model (Vision-LLM) includes a Vision-LLM, and an apparatus including at least one processor, and a memory accessible to the processor, the memory having stored therein at least one of programs or instructions. In some embodiments, when the programs or instructions are executed by the processor, the system is configured to decompose an original task request associated with an image and received at the Vision-LLM into sub-tasks to divide the received task request into less complex sub-tasks, convert the sub-tasks into code to select at least one respective tool for a performance of each sub-task, perform each sub-task using the selected, respective tool, aggregate the results of the sub-task performances, and apply reasoning to the aggregated results to determine if the original task request was performed correctly.

In some embodiments, a non-transitory computer readable medium having stored thereon instructions that, when executed by one or more processors, cause the one or more processors to perform operations for task performance in a Vision Large Language model (Vision-LLM), that include decomposing an original task request associated with an image and received at the Vision-LLM into sub-tasks to divide the received task request into less complex sub-tasks, converting the sub-tasks into code to select at least one respective tool for a performance of each sub-task, performing each sub-task using the selected, respective tool, aggregating the results of the sub-task performances, and applying reasoning to the aggregated results to determine if the original task request was performed correctly.

In some embodiments, a task performance system of the present invention, such as the task performance system 100 of FIG. 1, can be implemented to verify a correctness of an answer (e.g., claim) generated by the Vision-LLM (e.g., the LVLM 130) to a question input to the Visio-LLM. In embodiments in which a task performance system of the present invention, such as the task performance system 100 of FIG. 1, is being implemented to verify a correctness of an answer to a question generated by the LVLM 130, the Vision-LLM task performance system 100 of FIG. 1 receives outputs from the LVLM 130, which provides an answer â=V(I, \hat{q}) to the question, \hat{q}, for a given image I∈RM×N×3, in which M and N represent the height and width of the image. In embodiments of the present principles, the question-answer pair, (\hat{q}, â), are combined into a claim, C, about the image using, for example, the optional claims construction module 105. In accordance with the present principles, the problem of detecting and correcting hallucinations associated with the answer, â, is formulated as a visual claim verification task including inputs (I, C) and outputs (d, r), in which d∈{correct, incorrect} and r refer to the decision regarding the correctness of the claim and a rewrite (if needed) respectively.

In accordance with embodiments of the present principles, the optional grounding module 110 of the Vision-LLM task performance system 100 of FIG. 1, can implement object detectors to ground visual entities in the given image relevant to the claim. In some embodiments, the grounding module 110 implements a pipeline that utilizes YOLO and Grounding-DINO to determine the presence and location of objects in a given image. Given the image and the claim, the grounding module 110 can produce a visual table representation by first parsing the claim using an LLM with in-context examples to identify key entities that are tangible and that can be visually grounded. This is done to reduce the likelihood of false positives. For example, the claim “What is the color of the motorcycle in the image” can be parsed into {motorcycle}. This entity is then identified to the object detectors to create the visual table.

In this specific embodiment of the present principles, a pipeline of the grounding module 110 of the Vision-LLM task performance system 100 of FIG. 1, used to detect objects referenced in a claim, integrates both YOLOv9 and Grounding DINO. YOLOv9 which is a closed vocabulary set and Grounding DINO which offers an open-vocabulary set, balances the strengths and weaknesses of both tools. Closed vocabulary models like YOLOv9 are reliable for the classes on which they are trained but fail to detect novel classes. Conversely, open-vocabulary models like Grounding DINO can detect novel objects but may produce false positives, such as mistakenly identifying a pillow in an image that isn't present. As such, a pipeline in accordance with the present principles first checks if the object class is present in YOLOv9's closed set and if the class exists and YOLOv9 does not detect the object, it is concluded that the object is not found. If the class is not present, Grounding DINO is used to verify the object's presence. Additionally, in some embodiments, a bounding box verification tool is implemented, which uses the coordinates of detected objects and queries a VQA module (LLaVA-v1.6) to confirm if the objects are in fact present in the image, enhancing the accuracy of the implemented detection system.

Because answering simpler questions about images using external tools (i.e., determining if an object exists) is more reliable than answering more complicated questions, embodiments of the present principles decompose a visual claim, C, into sub-claims. In some embodiments, each sub-claim is represented as a pair consisting of a predicate and its corresponding question (pᵢ, qᵢ). Each (qᵢ) can be conceptualized as a node in a computational graph, in which the edges represent the logical connections between the questions.

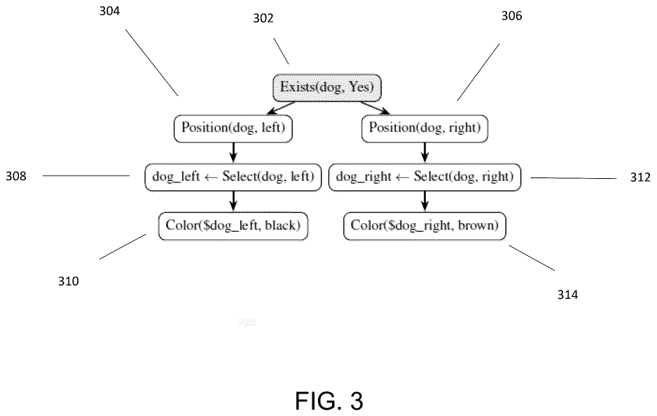

FIG. 3 depicts a graphical representation 300 of a computational graph of generated sub-claims of the present principles including predicates as the node and edges defined by their dependencies in accordance with at least one embodiment of the present principles. In the computational graph 300 of FIG. 3, a first node 302 predicate sub-question in which a tool (e.g., object detector) was used to determine that a dog exits in a subject image. The embodiment of FIG. 3 illustratively includes a second node 304 predicate sub-question in which a tool was used to determine that there is a dog positioned on the left of the image and a third node 306 predicate sub-question in which a tool was used to determine that there is a dog positioned on the right of the image. The embodiment of FIG. 3 further includes a fourth node 308 predicate sub-question in which a tool was used to select the dog positioned on the left of the image and a fifth node 310 predicate sub-question in which a tool was used to determine that the color of the dog positioned on the left of the image is black. The embodiment of FIG. 3 further includes a sixth node 312 predicate sub-question in which a tool was used to select the dog positioned on the right of the image and a seventh node 314 predicate sub-question in which a tool was used to determine that the color of the dog positioned on the right of the image is brown. In some embodiments, this graph structure of the present principles is employed to reason about the claim and to determine its veracity by systematically answering the sub-claims.

To perform the decomposition of the claims, the claim decomposition module 115 of the Vision-LLM task performance system 100 of FIG. 1 can define a set of predicates, such as Exists and Position, which are loosely structured based on a taxonomy of questions posed in VQA tasks. These predicates serve as the foundation for deriving specific questions. For instance, a claim involving an object's properties and interactions can be broken down into predicates concerning the presence, attributes, and relations of that object. Upon determining the predicates, the claim decomposition module 115 can select a respective tool for executing the action of the predicate.

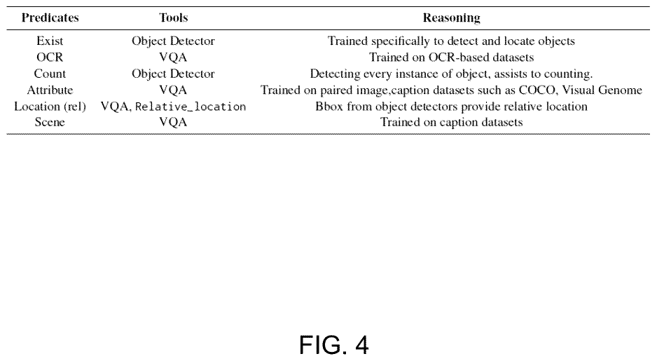

For example, FIG. 4 depicts a Table including examples of predicates determined by, for example, the claim decomposition module 115, respective tools selected to execute the action of the predicate, and the reasoning of the implementation of the tool in accordance with at least one embodiment of the present principles. Specifically, in the Table of FIG. 4, the first row includes a determined predicate of “Exist” having an associated selected tool of “Object Detector” and a Reasoning of “to detect and locate objects”; a second row of the Table of FIG. 4 includes a determined predicate of “OCR”, a selected tool of “VQA”, and a Reasoning of “Trained on OCR-based datasets”; a third row of the Table of FIG. 4 includes a determined predicate of “Count”, a selected tool of “Object Detector”, and a Reasoning of “Detecting every instance of object, assists to counting”; a fourth row of the Table of FIG. 4 includes a determined predicate of “Attribute”, a selected tool of “VQA”, and a Reasoning of “Trained on paired image, caption datasets such as COCO, Visual Genome”; a fifth row of the Table of FIG. 4 includes a determined predicate of “Location (rel)”, a selected tool of “VQA, Relative_location”, and a Reasoning of “Bbox from object detectors provide relative location”; and a sixth row of the Table of FIG. 4 includes a determined predicate of “Scene”, a selected tool of “VQA”, and a Reasoning of “Trained on caption datasets”.

In accordance with embodiments of the present principles, the claim decomposition module 115 of the Vision-LLM task performance system 100 of FIG. 1 transforms the claim, C, into predicates by prompting an LLM with in-context examples, using a set of ~10 examples covering all the predicates and scenarios, such as claims with negations. Additionally, the claim decomposition module 115 can generate a chain of questions grounded in each of the predicates.

In some embodiments, the claim decomposition module 115 can introduce intermediate variables, v, to reference specific object instances, which can be critical in verifying claims about specific object instances. That is, the intermediate variable, v, of the present principles helps embodiments of the present principles to reference specific object instances (e.g. object on the right). Such a process of the present principles improves verification of complex questions requiring contextual reasoning around multiple objects and enables the creation of dependencies between nodes of a computational graph of the present principles, which not only reduces computational redundancy but also improves the reliability of the verification process.

To verify each sub-claim generated by the claim decomposition module 115, the coding module 120 of the Vision-LLM task performance system 100 of FIG. 1 generates a visually grounded answer to each sub-question, qᵢ by implementing executable code to solve complex problems, rather than using natural language. For example, in some embodiments, the coding module 120 implements a PoT-based strategy to synthesize programmatic instructions that compose different visual tools to infer the answers to the sub-claims. For example, a question about the color of an object might be translated into a code snippet that first uses a detector to crop the object and then applies a VQA tool to determine the object's color in the image. A key advantage of using code to answer the question, in accordance with the present principles, is the ability to combine different visual tools flexibly with Python operators. The coding step of the present principle performed by, for example, the coding module 120 can be denoted by the function λ, which represents using a subject image, current question(s), and the context from questions and answer(s) to generate Python code, cₖ, which can be denoted as λ(T, qk, {qi, ai}k−1)=ck, which can then be used to derive the answer as ak=exec(ck), where exec is a python interpreter. To perform robust verification when verifying each sub-claim, the coding module 120 shares computations between sub-claims. That is, the coding module provides the answers derived in previous sub-claims as context when answering a next question in a chain of sub-claims. This process can reduce duplicate computations, adaptively correct follow-up questions and can also catch inconsistencies in the reasoning process resulting from errors in visual tools being applied. For example, a follow up question about color of a car might not realize that multiple cars are present in the image and may thus end up generating code without loops over the object.

The answers generated by the coding module 120 from the sub-claims using the PoT-based verification are implemented by the reasoning module 125 of the Vision-LLM task performance system 100 of FIG. 1 to perform a comprehensive reasoning assessment and determine the validity of the original claim(s). The reasoning of the present principles is crucial for detecting hallucinations and for drawing accurate and reliable conclusions. That is in some embodiments, the reasoning module 125 aggregates the responses to each sub-claim to make an informed decision about the overall validity of the claim. Such process can be denoted as d, r=V(C, P, {qᵢ, aᵢ}^{K}ᵢ₌₁), in which the function V takes in the original claim, predicate, and questions and answers from the subclaims and outputs d, r which denotes the decision and, in some embodiments, a re-write for a claim(s) that contains hallucinations. In some embodiments, to verify the validity of a claim, the reasoning module 125 can implement an LLM (e.g. LVLM 70) by using a detailed instruction and a few in-context examples that encourages the LLM to verify the claim by considering the evidence along with the consistency and coherence of the generated answers using, in some embodiments, Chain-of-Thought (CoT)-style reasoning. In such embodiments, discrepancies or inconsistencies can be flagged as potential hallucinations, prompting a closer inspection of the questionable elements. This cross-examination of the present principles helps in identifying errors that may have arisen due to incorrect or ambiguous interpretations of the visual data. To mitigate hallucinations, the reasoning module 125 uses the same LLM (e.g., LVLM 70) to rewrite the original claim based on the verified answers. Some embodiments for rewriting the original claim include rephrasing the claim to eliminate elements that were identified as hallucinated or incorrect.

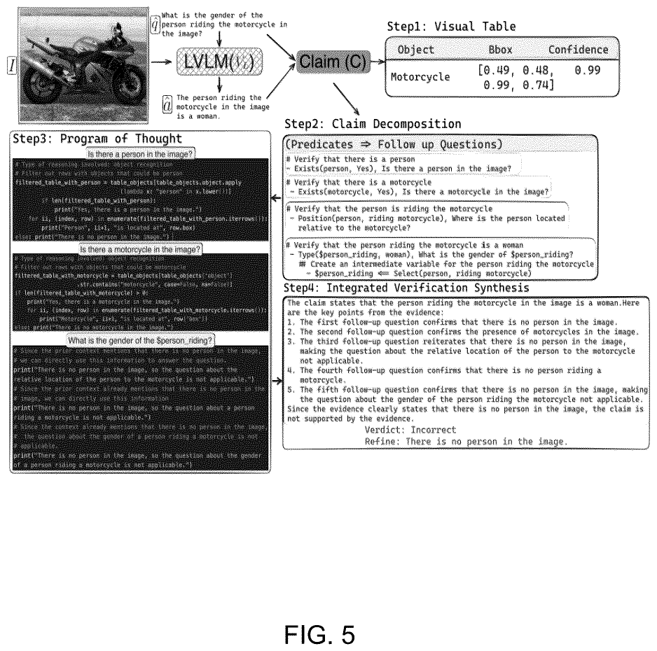

FIG. 5 graphically depicts a functional diagram of the operation of a Vision-LLM task performance system of the present principles, such as the Vision-LLM task performance system 100 of FIG. 1, in accordance with at least one embodiment of the present principles. In FIG. 5, an initial step of a process for identifying and correcting hallucinations in an LVLM 70 includes combining a question, \hat{q}, (illustratively in FIG. 5, “What is the gender of the person riding the motorcycle in the image”) about an image 505 input to the LVLM 70 with an answer, â, (illustratively in FIG. 5 “The person riding the motorcycle in the image is a woman”) output from the LVLM 70 into a claim, C. In some embodiments in a Vision-LLM task performance system of the present principles, such as the Vision-LLM task performance system 100 of FIG. 1, the claim, C, can be generated by the claim construction module 105.

Subsequently, the grounding module 110 of the Vision-LLM task performance system 100 of FIG. 1, can implement object detectors to ground visual entities in the given image relevant to the claim, C. For example, in the embodiment of FIG. 5, a visual table is constructed identifying a relevant object in the image relative to the claim, C, as the motorcycle, identifying a bounding box of the motorcycle, and identifying a confidence score related to the presence of the object as 0.99. In some embodiments of the present principles, the confidence score is determined using a tool implemented to detect the object.

As depicted in the embodiment of FIG. 5, the claim, C, can be decomposed into granular sub-claims and follow-up questions by, for example, the claim decomposition module 115 of the Vision-LLM task performance system 100 of FIG. 1. In the embodiment of FIG. 5, a set of predicates are used to generate a list of granular sub-claims and follow-up questions. For example, in the embodiment of FIG. 5, the predicate “verify” is used to generate a question to attempt to determine if there is a person in the image, and to generate a question to attempt to determine if there is a motorcycle in the image, and to generate a question to attempt to determine if the person is riding the motorcycle. In the embodiment of the FIG. 5, a sub-claim has been generated by, for example, the claim decomposition module 115 of the Vision-LLM task performance system 100 of FIG. 1, that includes an intermediate variable, $person_riding, that is used for referencing a specific object. More specifically, in the embodiment of FIG. 5, a sub-claim includes a question to attempt to determine if the person riding the motorcycle is a woman.

In the embodiment of FIG. 5, the generated sub-claims/questions are translated into Python code using the POT approach by, for example, the coding module 120 of the Vision-LLM task performance system 100 of FIG. 1. In the embodiment of FIG. 5, for the question “is there a person in the image”, the type of reasoning identified in the POT approach is object recognition. The POT approach identifies that there is no person in the image. In the embodiment of FIG. 5, for the question “is there a motorcycle in the image”, the type of reasoning identified in the POT approach is object recognition. The POT approach identifies that there is a motorcycle in the image and location of the motorcycle in the image. In FIG. 5, for the question “Where is the person located relative to the motorcycle” and the intermediate question “is the person riding the motorcycle a woman”, the POT approach reasons that because it was identified that there is no person in the image, the two last sub-questions are identified as non-applicable.

In the embodiment of FIG. 5, Integrated Verification Synthesis is implemented by, for example, the reasoning module 125 of the Vision-LLM task performance system 100 of FIG. 1 to perform comprehensive reasoning assessments to validate the original claim(s) using the information determined by the POT approach from the sub-claims/questions. For example, in the reasoning of the embodiment of FIG. 5, it is indicated that the first follow-up question confirms that there is no person in the image and the second follow-up question confirms that there is a motorcycle in the image. The reasoning of the embodiment of FIG. 5 further indicates that the third follow-up question reiterates that there is no person in the image, making the question about the relative location of the person to the motorcycle not applicable. The reasoning of the embodiment of FIG. 5 further indicates that the fourth follow-up question confirms that there is no person riding a motorcycle and that the fifth follow-up question confirms that there is no person in the image, making the question about the gender of the person riding the motorcycle in the image not applicable. In the embodiment of FIG. 5, the result of the reasoning is that, since the evidence clearly states that there is no person in the image, the original claim, C, is not supported by the evidence. In the embodiment of FIG. 5, a verdict of the reasoning of the present principles performed by, for example, the reasoning module 125 of the Vision-LLM task performance system 100 of FIG. 1, is that the original claim, C, is incorrect.

In the embodiment of FIG. 5, a suggestion can be made by, for example, the reasoning module 125 of the Vision-LLM task performance system 100 of FIG. 1, for a refined answer, a, “There is no person in the image” from the LVLM 70 in response to the original question, \hat{q}, (illustratively in FIG. 5, “What is the gender of the person riding the motorcycle in the image”).

FIG. 6B depicts a flow diagram of a method for identifying and correcting hallucinations in vison large language models in accordance with at least one embodiment of the present principles. The method 650 can begin at 652 during which a question received by the vision large language model (Vision-LLM) with regards to an image and an answer produced by the vision large language model in response to the received question about the image are converted into an original claim. The method 650 can proceed to optional step 653.

At optional step 653, a visual table is created for objects identified in the original claim to identify the objects in the image. The method 650 can proceed to 654.

At 654, the original claim is decomposed into sub-claims to divide the received question into less complex sub-questions. For example and as described above, in some embodiments a machine learning model can be implemented to decompose the original claim into sub-claims In some embodiments of the present principles, the decomposing further includes generating an intermediate variable to ground at least one object in the image. The method 650 can proceed to 656.

At 656, the sub-claims are converted to code to determine answers to the sub-claims. For example and as described above, in some embodiments, Program-of-Thought (POT) prompting is used to generate Python code for determining answers to the sub-claims through flexible composition/calling of tools (e.g., external tools). The method 650 can proceed to 658.

At 658, reasoning is applied to the determined answers to the sub-claims to determine a correctness of the original claim. For example and as described above, in some embodiments, the reasoning capabilities of an associated LLM, such as the Vision-LLM can be implemented to determine a correctness of the original claim. If at step 608, the reasoning results in a concurrence of the original claim, the original claim is identified as correct. If at step 658, the reasoning results in a negation of the original claim, the original claim is identified as incorrect. In some embodiments, the reasoning can be applied using the vision large language model that received the question and provided the answer. The method 650 can proceed to step 660.

At step 660, a refinement can be made to and/or suggest for the original claim based on the results of the reasoning.

The method 650 can exit at 662.

In some embodiments, the refinement can include at least one of an alternative to the original claim or a modification of the original claim.

Embodiments of the present principles can be implemented in any content retrieval system to receive natural language tasks requests and perform the task requests in accordance with the present principles. In embodiments in which embodiments of the present principles are directed to text content only LLMs, a system of the present principles can be used to perform task requests regarding the content such as to determine a valence of the text of the LLM.

As depicted in FIG. 1, embodiments of a Vision-LLM task performance system of the present principles, such as the Vision-LLM task performance system 100 of FIG. 1, can be implemented in a computing device 700. For example, FIG. 7 depicts a high-level block diagram of a computing device 700 suitable for use with embodiments of a Vision-LLM task performance system of the present principles, such as the Vision-LLM task performance system 100 of FIG. 1. In the embodiment of FIG. 7, the computing device 700 includes one or more processors 710a-710n coupled to a system memory 720 via an input/output (I/O) interface 730. The computing device 700 further includes a network interface 740 coupled to I/O interface 730, and one or more input/output devices 750, such as cursor control device 760, keyboard 770, and display(s) 780. In various embodiments, a user interface can be generated and displayed on display 780. In some cases, it is contemplated that embodiments can be implemented using a single instance of a computing device 700, while in other embodiments multiple such systems, or multiple nodes making up the computing device 700, can be configured to host different portions or instances of various embodiments. For example, in one embodiment some elements can be implemented via one or more nodes of the computing device 700 that are distinct from those nodes implementing other elements. In another example, multiple nodes may implement the computing device 700 in a distributed manner.

In different embodiments, the computing device 700 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 700 can be a uniprocessor system including one processor 710, or a multiprocessor system including several processors 710 (e.g., two, four, eight, or another suitable number). Processors 710 can be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 can be configured to store program instructions 722 and/or, in some embodiments, machine learning systems that are accessible by the processor 710. In various embodiments, system memory 720 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 720. In other embodiments, program instructions and/or data can be received, sent or stored upon different types of computer-accessible media or on similar media separate from the system memory 720 or the computing device 700.

In one embodiment, I/O interface 730 can be configured to coordinate I/O traffic between processor 710, system memory 720, and any peripheral devices in the device, including network interface 740 or other peripheral interfaces, such as input/output devices 750. In some embodiments, I/O interface 730 can perform any necessary protocol, timing or other data transformations to convert data signals from one component (e.g., system memory 720) into a format suitable for use by another component (e.g., processor 710). In some embodiments, I/O interface 730 can include support for devices attached through various types of peripheral buses, such as a variant of the Peripheral Component Interconnect (PCI) bus standard or the Universal Serial Bus (USB) standard, for example. In some embodiments, the function of I/O interface 730 can be split into two or more separate components, such as a north bridge and a south bridge, for example. Also, in some embodiments some or all of the functionality of I/O interface 730, such as an interface to system memory 720, can be incorporated directly into processor 710.

Network interface 740 can be configured to allow data to be exchanged between the computing device 700 and other devices attached to a network (e.g., network 790), such as one or more external systems or between nodes of the computing device 700. In various embodiments, network 790 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 can, in some embodiments, include one or more display terminals, keyboards, keypads, touchpads, scanning devices, voice or optical recognition devices, or any other devices suitable for entering or accessing data by one or more computer systems. Multiple input/output devices 750 can be present in computer system or can be distributed on various nodes of the computing device 700. In some embodiments, similar input/output devices can be separate from the computing device 700 and can interact with one or more nodes of the computing device 700 through a wired or wireless connection, such as over network interface 740.

Those skilled in the art will appreciate that the computing device 700 is merely illustrative and is not intended to limit the scope of embodiments. In particular, the receiver/control unit and peripheral devices can include any combination of hardware or software that can perform the indicated functions of various embodiments, including computers, network devices, Internet appliances, PDAs, wireless phones, pagers, and the like. The computing device 700 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 700 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 700 can further include a web browser.

Although the computing device 700 is depicted as a general purpose computer, the computing device 700 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

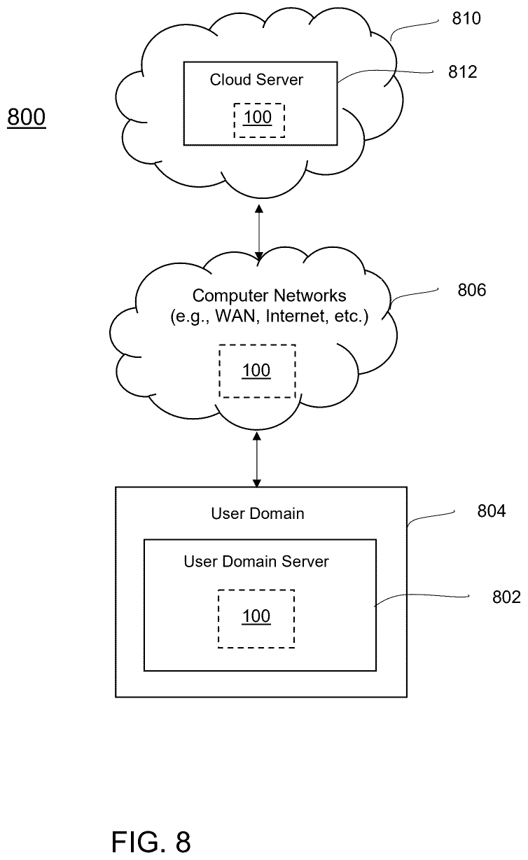

FIG. 8 depicts a high-level block diagram of a network in which embodiments of a Vision-LLM task performance system in accordance with the present principles, such as the Vision-LLM task performance system 100 of FIG. 1, can be implemented. The network environment 800 of FIG. 8 illustratively comprises a user domain 802 including a user domain server/computing device 804. The network environment 800 of FIG. 8 further comprises computer networks 806, and a cloud environment 810 including a cloud server/computing device 812.

In the network environment 800 of FIG. 8, an Vision-LLM task performance system in accordance with the present principles, such as the Vision-LLM task performance system 100 of FIG. 1, can be included in at least one of the user domain server/computing device 804, the computer networks 806, and the cloud server/computing device 812. That is, in some embodiments, a user can use a local server/computing device (e.g., the user domain server/computing device 804) to identify and correct hallucinations in a Vision LLM in accordance with the present principles. In some embodiments, a user can implement a Vision-LLM task performance system in accordance with the present principles, such as the Vision-LLM task performance system 100 of FIG. 1 in the computer networks 806 to identify and correct hallucinations in an Vision LLM in accordance with the present principles. Alternatively or in addition, in some embodiments, a user can provide a Vision-LLM task performance system of the present principles in the cloud server/computing device 812 of the cloud environment 810. For example, in some embodiments it can be advantageous to perform processing functions of the present principles in the cloud environment 810 to take advantage of the processing capabilities and storage capabilities of the cloud environment 810.

In some embodiments in accordance with the present principles, a Vision-LLM task performance system in accordance with the present principles can be located in a single and/or multiple locations/servers/computers to perform all or portions of the herein described functionalities of a system in accordance with the present principles. For example, in some embodiments some components of a Vision-LLM task performance system of the present principles can be located in one or more than one of the user domain 802, the computer network environment 806, and the cloud environment 810 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from a computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present principles, other and further embodiments of the invention can be devised without departing from the basic scope thereof, and the scope thereof is determined by the claims that follow.

1. A method for task performance in a Vision Large Language model (Vision-LLM), the method comprising:
decomposing an original task request associated with an image and received at the Vision-LLM into sub-tasks to divide the received task request into less complex sub-tasks;
converting the sub-tasks into code to select at least one respective tool for a performance of each sub-task;
performing each sub-task using the selected, respective tool;
aggregating the results of the sub-task performances; and
applying reasoning to the aggregated results to determine if the original task request was performed correctly.

2. The method of claim 1, further comprising determining a refinement to the aggregated results if needed, based on the determination if the original task request was performed correctly.

3. The method of claim 1, wherein the code comprises Python code using the Program of Thought (POT) approach.

4. The method of claim 1, further comprising generating an intermediate variable of the sub-tasks to ground at least one object in the image.

5. The method of claim 1, further comprising creating a visual table from the original task request for objects identified in the original task request to identify at least one object in the image.

6. The method of claim 5, wherein identifying at least one object in the image comprises determining a bounding box for the at least one identified object and determining a confidence score for the at least one identified object.

7. The method of claim 1, wherein the task request comprises verifying if a question answered by the Vision-LLM regarding an image is correct and the method comprises:
converting the question received by the Vision-LLM and the answer produced by the Vision-LLM in response to the received question about the image into an original claim;
decomposing the original claim into sub-claims to divide the received question into less complex sub-questions;
converting the sub-claims into code to select at least one respective tool for determining an answer to each sub-questions;
applying reasoning to the determined answers to the sub-questions to determine a correctness of the original claim; and
determining a refinement for the original claim if needed, based on the determined correctness of the original claim.

8. The method of claim 7, wherein the refinement comprises at least one of an alternative to the original claim or a modification of the original claim.

9. An apparatus for task performance in a Vision Large Language model (Vision-LLM), the apparatus comprising:
at least one processor; and
a memory accessible to the processor, the memory having stored therein at least one of programs or instructions executable by the processor to configure the apparatus to:
decompose an original task request associated with an image and received at the Vision-LLM into sub-tasks to divide the received task request into less complex sub-tasks;
convert the sub-tasks into code to select at least one respective tool for a performance of each sub-task;
perform each sub-task using the selected, respective tool;
aggregate the results of the sub-task performances; and
apply reasoning to the aggregated results to determine if the original task request was performed correctly.

10. The apparatus of claim 9, wherein the apparatus is further configured to determine a refinement to the aggregated results if needed, based on the determination if the original task request was performed correctly.

11. The apparatus of claim 9, wherein the code comprises Python code using the Program of Thought (POT) approach.

12. The apparatus of claim 9, wherein the apparatus is further configured to generate an intermediate variable of the sub-tasks to ground at least one object in the image.

13. The apparatus of claim 9, wherein the apparatus is further configured to generate a visual table from the original task request for objects identified in the original task request to identify at least one object in the image.

14. The apparatus of claim 13, wherein identifying at least one object in the image comprises determining a bounding box for the at least one identified object and determining a confidence score for the at least one identified object.

15. The apparatus of claim 9, wherein the original task request comprises verifying if a question answered by the Vision-LLM regarding an image is correct and the apparatus is configured to:
convert the question received by the Vision-LLM and the answer produced by the Vision-LLM in response to the received question about the image into an original claim;
decompose the original claim into sub-claims to divide the received question into less complex sub-questions;
convert the sub-claims into code to select at least one respective tool for determining an answer to each sub-questions;
apply reasoning to the determined answers to the sub-questions to determine a correctness of the original claim; and
determine a refinement for the original claim if needed, based on the determined correctness of the original claim.

16. The apparatus of claim 15, wherein the refinement comprises at least one of an alternative to the original claim or a modification of the original claim.

17. A system for task performance in a Vision Large Language model (Vision-LLM), comprising:
a Vision-LLM;
an apparatus, comprising:
at least one processor; and
a memory accessible to the processor, the memory having stored therein at least one of programs or instructions executable by the processor to configure the system to:
decompose an original task request associated with an image and received at the Vision-LLM into sub-tasks to divide the received task request into less complex sub-tasks;
convert the sub-tasks into code to select at least one respective tool for a performance of each sub-task;
perform each sub-task using the selected, respective tool;
aggregate the results of the sub-task performances; and
apply reasoning to the aggregated results to determine if the original task request was performed correctly.

18. The system of claim 17, wherein the original task request comprises verifying if a question answered by the Vision-LLM regarding an image is correct and the system is configured to:
convert the question received by the Vision-LLM and the answer produced by the Vision-LLM in response to the received question about the image into an original claim;
decompose the original claim into sub-claims to divide the received question into less complex sub-questions;
convert the sub-claims into code to select at least one respective tool for determining an answer to each sub-questions;
apply reasoning to the determined answers to the sub-questions to determine a correctness of the original claim; and
determine a refinement for the original claim if needed, based on the determined correctness of the original claim.

19. A non-transitory computer readable storage medium having stored thereon instructions that, when executed by one or more processors, cause the one or more processors to perform operations for task performance in a Vision Large Language model (Vision-LLM), that include:
decomposing an original task request associated with an image and received at the Vision-LLM into sub-tasks to divide the received task request into less complex sub-tasks;
converting the sub-tasks into code to select at least one respective tool for a performance of each sub-task;
performing each sub-task using the selected, respective tool;
aggregating the results of the sub-task performances; and
applying reasoning to the aggregated results to determine if the original task request was performed correctly.

20. The non-transitory computer readable storage medium of claim 19, wherein the original task request comprises verifying if a question answered by the Vision-LLM regarding an image is correct and the task operations include:
converting the question received by the Vision-LLM and the answer produced by the Vision-LLM in response to the received question about the image into an original claim;
decomposing the original claim into sub-claims to divide the received question into less complex sub-questions;
converting the sub-claims into code to select at least one respective tool for determining an answer to each sub-questions;
applying reasoning to the determined answers to the sub-questions to determine a correctness of the original claim; and
determining a refinement for the original claim if needed, based on the determined correctness of the original claim.
